(19) United States
(12) Patent Application Publication
(10) Pub. No.: US 2014/0019610 A1
(43) Pub. Date: Jan. 16, 2014

(54) Correlated Tracing of Connections through TDS

(71) Applicants: Rong Wu, Redmond, WA (US); Cheryan Jacob, Redmond, WA (US); Jerome R. Halmans, Monroe, WA (US); Xinwei Hong, Sammamish, WA (US); Peter Gvozdjak, Bellevue, WA (US); Young Gah Kim, Bothell, WA (US)

(72) Inventors: Rong Wu, Redmond, WA (US); Cheryan Jacob, Redmond, WA (US); Jerome R. Halmans, Monroe, WA (US); Xinwei Hong, Sammamish, WA (US); Peter Gvozdjak, Bellevue, WA (US); Young Gah Kim, Bothell, WA (US)

(73) Assignee: MICROSOFT CORPORATION, Redmond, WA (US)

(21) Appl. No.: 13/545,365

(22) Filed: Jul. 10, 2012

(51) Int. Cl. G06F 15/173

(52) U.S. Cl. 709/224

(57) ABSTRACT

A trace identifier is sent between a database client and a database server using a pre-login data package along with pre-login connection open requests through the TDS protocol. The trace identifier gets logged by client-side connection-related traces, by server-side traces, and by database engine traces. The trace identifier can be used to exactly correlate a physical connection on the client to a physical connection on the server. This enhances troubleshooting of the database system, particularly when there are many concurrent users and threads.

### BACKGROUND

The Tabular Data Stream (TDS) protocol is an application-level protocol used for the transfer of requests and responses between clients and database server systems, such as SQL Server®, in enterprise and cloud-based systems. In such systems, the client will typically establish a long-lived connection with the server. Once the connection is established using a transport-level protocol, TDS messages are used to communicate between the client and the server. The TDS session is directly tied to the transport-level session, meaning that a TDS session is established when the transport-level connection is established and the server receives a request to establish a TDS connection. It persists until the transport-level connection is terminated, such as when a TCP socket is closed. TDS does not make any assumption about the transport protocol used, but assumes that the transport protocol supports reliable, in-order delivery of the data.

TDS includes facilities for authentication and identification, channel encryption negotiation, issuing of SQL batches, stored procedure calls, returning data, and transaction manager requests. TDS packets are encapsulated in the packets built for the protocol stack used by the Net-Libraries. For example, if the system uses the TCP/IP Sockets Net-Library, then the TDS packets are encapsulated in the TCP/IP packets of the underlying protocol.

In current database systems, a physical connection generated on a client driver cannot be correlated to a connection on the database server. Therefore, users cannot match what happened with the connection generated at the client machine to what was processed on the server. In one solution, developers may attempt to gather this information using network monitor or “netmon” tracing. Netmon tracing can be used to make a best case guess of which packet sent by TDS from the client correlated to what happened on the server. However, this solution does not work when the packets pass through a proxy server or used named pipes to connect. In another solution, for SQL Azure™ and SQL Server® post connection analysis, developers may query for connection identification information from system management views and store this value on the client driver to correlate the database's physical connection with the client connection that was opened. However, this solution only works post-login or when a connection open does not abruptly fail.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments provide correlated tracing of connections on client drivers to connections on the server. This tracing is accomplished using an optional pre-login data session that is added to the TDS protocol to enable correlated tracing of connections

In one embodiment, a sixteen-byte connection identifier is logged at each layer of the stack to enable correlation of connections. For example, the connection identifier may be logged using pre-login BID (Built-In Diagnostics) trace points on the client drivers, TDS protocol implementations, and server-side SNI (SQL Server Network Interface) layers. The connection identifier is exposed using APIs on the client connection object and exception object. The connection identifier sent through pre-login data packet logs into an Extended Event on the server to correlate a server connection to a client connection.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of an enterprise or on-premises client-server database system according to one embodiment.

FIG. 2 illustrates a distributed, virtual or cloud-based database system according to one embodiment.

FIG. 3 illustrates an example stack for a client-server database system.

FIG. 4 illustrates a PRELOGIN message stream with an optional Trace Identifier.

FIG. 5 is a flowchart illustrating a method or process for tracing connections at a client in a database system.

FIG. 6 is a flowchart illustrating a method or process for tracing connections at a database or server in a database system.

FIG. 7 illustrates an example of a suitable computing and networking environment.

### DETAILED DESCRIPTION

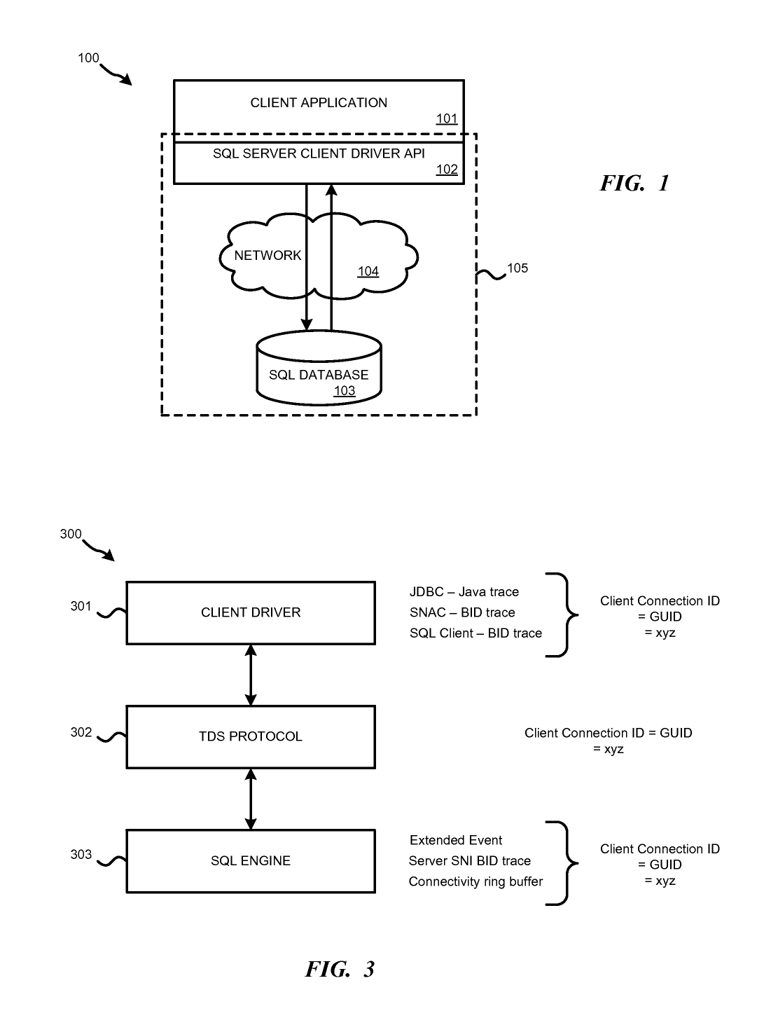

FIG. 1 is a high level block diagram of an enterprise or on-premises client-server database system 100 according to one embodiment. Client application 101 comprises code that is run on a client machine to provide database functionality to users. Client application 101 includes SQL Server® client driver API (Application Programming Interface) 102 that provides a connection to a SQL database 103 through network 104. The user can save data to SQL database 103 or query the database using client application 101 and SQL Server® client driver API 102. Region 105 represents a stack associated with SQL database 103. The area outside region 105 in client application 101 is customer-developed code, for example, while the area inside region 105 includes APIs for communicating with the database.

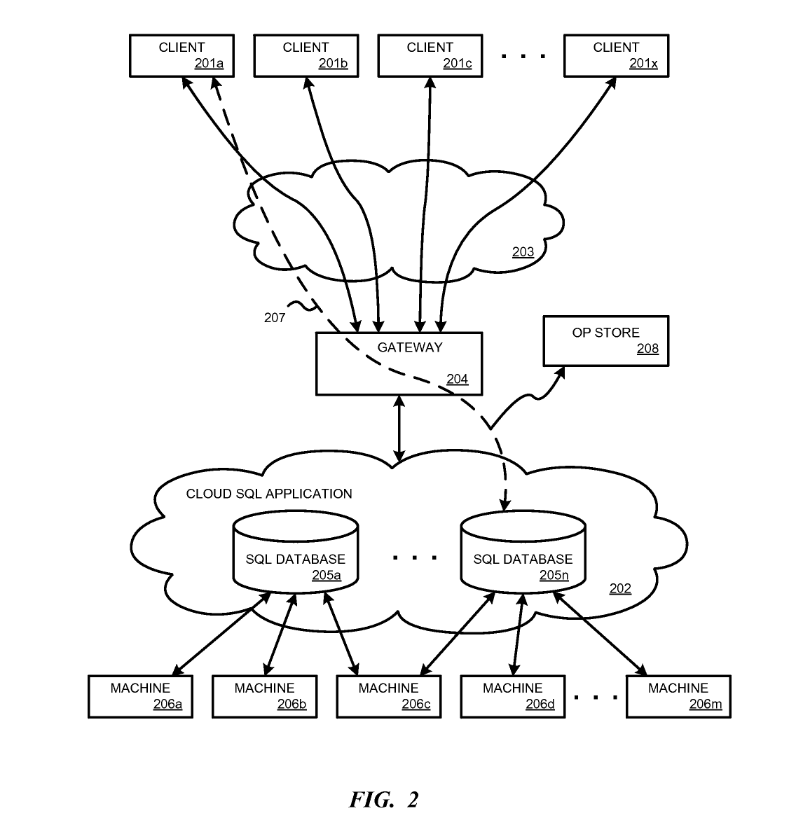

FIG. 2 illustrates a distributed, virtual or cloud-based database system according to one embodiment. A number of independent client applications 201a-x access a cloud SQL application 202 through a public or private network 203, which may be the Internet or an intranet. Client applications 201a-x use SQL server APIs or drivers to interface with cloud SQL application 202 similar to SQL Server® client driver API 102 in the enterprise system (FIG. 1). Individual requests from each client 201 are routed through network 203 to a gateway 204 that provides access to cloud SQL application 202. Gateway 204 may support authentication, provisioning and other services for the SQL database application. Cloud SQL application 202 may support a plurality of virtual SQL databases 205a-n. For example, each SQL database 205 may be associated with a particular user or client 201 or multiple clients 201 may access the same SQL database 205. In a typical distributed or cloud-based database service, there may be thousands of users and thousands of SQL databases 205. Each virtual SQL database is hosted on one or more physical machines 206a-m. For example, a primary copy of a SQL database 205a may reside on one machine 206a and other copies of the same SQL database 205 may also reside on other machines 206b,c for redundancy, scaling and other considerations.

In operation, each client 201 opens a connection 207 or pipe to a database 205. For example, a user at client 201 a enters a user-identifier and password to set-up a connection to database 205n. Requests, such as SQL batch and RPC requests, may be sent to the database 205n over that connection 207. When an error occurs on a connection 207 it is difficult to troubleshoot these problems in existing systems. All activity for connection 207, such as error messages, tracing, and logging, is captured to operation store (OP store) 208. There are thousands of connections active at one time. This creates a problem for a troubleshooter who often cannot determine which connection 207 is relevant to a particular client 201.

FIG. 3 illustrates an example stack 300 for a client-server database system. Inside stack 300, for example, there is a client driver layer 301, TDS protocol layer 302, and SQL engine layer 303. Client driver 301 may be, for example, SNAC (SQL Native Client), JDBC (Java Database Connectivity), or a SQL client such as ADO.NET (ActiveX Data Objects for .NET) depending upon the technology selected for the client application. SNAC combines an ODBC driver and OLE DB provider in a single DLL for Microsoft's SQL Server®. JDBC is a Java-based data access technology from Sun Microsystems, Inc. ADO.NET is a set of computer software components that programmers can use to access data and data services using the Microsoft .NET Framework. Client driver 301 may correspond to SQL Server® client driver API 102 in client application 101 or to a client 201, for example.

TDS protocol 302 is an application-level protocol used for the transfer of requests and responses between client driver 301 and database engine 303 as described above. SQL engine 303 corresponds to SQL database 103 (FIG. 1) or cloud SQL application 202 (FIG. 2), for example.

In a typical client application, the stack 300 is used by a client application to open a connection to a SQL Server and to execute requests. The client driver 301 first establishes a physical connection to the SQL server 303. The client driver 301 then sends a PRELOGIN packet to set up a context for login. An authentication mechanism is used to support user accounts on SQL server 303. The username and password of the user account are transmitted as part of the LOGIN message that the client sends to the server. The client 301 may have more than one connection to the server 303, but each one is established separately in the same way. After the server 303 has received the login record from the client 301, it will notify the client 301 that it has either accepted or rejected the connection request.

The client application will sometimes fail when it attempts to connect to the database. For example, the client application may fail if the network is down due to a bad router or a network hardware problem. Other failures may occur when the application running on the client machine is slow to send the request, the client machine crashes, or the client driver fails. Problems with the SQL engine may also cause failures, such as when the SQL Server is too busy to respond to a connection request. In existing systems, there is no way to determine what caused these failures. Instead, users could track a packet through each part of the stack in an attempt to identify how far a packet traveled through the system and thereby determine where a failure occurred. Because thousands of packets are sent thorough the system, it was very difficult to identify and track individual packets. Therefore, it is difficult to trouble shoot the system and to correlate what happened at the client driver to what happened at the SQL engine.

In one embodiment, an optional Trace Identifier may be added to the TDS protocol for the PRELOGIN message stream in a way that does not interfere with the protocol. The Trace Identifier acts as a “breadcrumb” so that PRELOGIN packets may be tracked through the system. When the Trace Identifier is present in the stack, this Trace Identifier is captured and persisted or logged at each layer 301-303. Each layer has different tracing mechanisms as illustrated in FIG. 3. For example, depending upon the technology selected in the client driver 301, JDBC uses event logging and SNAC and SQL Client use BID tracing. The TDS protocol 302 uses BID trace, and SQL Engine 303 may use Extended Event, connection ring buffer, or BID trace. The Trace Identifier leaves “breadcrumbs” inside each tracing mechanism so that the user can exactly know where a PRELOGIN packet has been. This allows the user to map the PRELOGIN packet through the system.

In one embodiment, the Trace Identifier is a randomly generated sixteen-byte GUID (Globally Unique Identifier) referred to herein as a Client Connection ID. The Client Connection ID is added to the PRELOGIN message. When the Client Connection ID is sent and tracing is turned on within client driver 301, for example, the GUID will be found within the trace points for the client driver. Similarly, within TDS protocol 302 and SQL Engine 303 tracing, the GUID will also be found. As illustrated in FIG. 3, if the randomly generated sixteen-byte GUID is “xyz,” then that identifier “xyz” will be found in the tracing for each layer of the stack.

In another embodiment, the Trace Identifier is a Client Connection ID plus an Activity ID, which is a randomly generated sixteen-byte GUID plus a four-byte sequence number. The Activity ID GUID corresponds to a thread on the client machine, and the sequence number is assigned to a message sent by that thread.

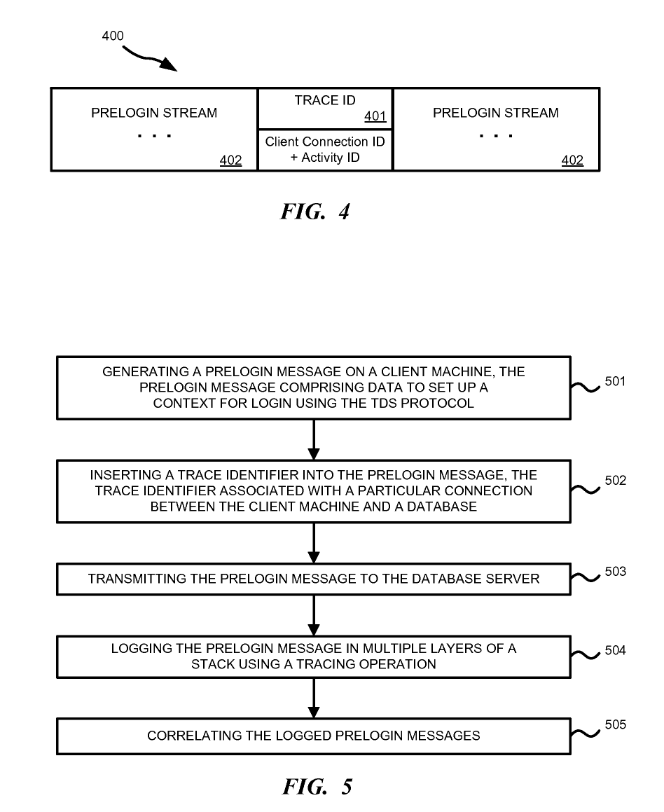

FIG. 4 illustrates a PRELOGIN message stream 400 with an optional Trace Identifier (Trace ID) 401, which may be a Client Connection ID in the form of a randomly generated sixteen-byte GUID plus an Activity ID in the form of a randomly generated sixteen-byte GUID plus a four-byte sequence number. The Trace ID is included with other elements of a predefined PRELOGIN stream 402.

The Trace ID—along with its Client Connection ID and Activity ID components—is logged by tracing in each layer of the stack. The PRELOGIN message can then be tracked across the system and through the stack by looking for the specific Trace ID assigned to the PRELOGIN stream. If the Trace ID does not appear in the trace for a particular layer, then the failure point of the PRELOGIN attempt can be identified. For example, if the Trace ID does not appear in TDS, then the user knows that the PRELOGIN packets did not reach the TDS protocol. Similarly, if the Trace ID is not found in the SQL Engine, then the user knows that the PRELOGIN stream from the client did not reach the server. This assists the user in identifying the source of a network problem.

In other embodiments, the Trace ID may be used to identify particular connections out of thousands of connections in the network, thereby allowing the user to focus on specific connections that have failed or are having problems. For example, in a cloud environment, a user can identify the Client Connection ID for a failed connection and a troubleshooter use trace data to analyze the connection. This allows a connection to be analyzed anywhere between the client application and a physical machine or a logical database residing on a machine. A client application may be written to store the Trace ID data for connections that generate error messages. That Trace ID can then be used for troubleshooting the connection.

FIG. 5 is a flowchart illustrating a method or process for tracing connections at a client in a database system. In step 501, a prelogin message is generated on a client machine. The prelogin message comprises data to set up a context for login using the TDS protocol. In step 502, a trace identifier is inserted into the prelogin message. The trace identifier is associated with a particular connection between the client machine and a database. In step 503, the prelogin message is transmitted to the database.

The prelogin message is logged in one or more layers of a stack using a tracing operation in step 504. Logging of the prelogin message may occur in a client driver stack layer, a TDS protocol stack layer, and/or a database server stack layer. In step 505, the logged prelogin messages from the client driver stack layer, the TDS protocol stack layer, and/or the database server stack layer are correlated. The connection may be between the client machine and an on-premises database. Alternatively, the connection may be between the client machine and a virtual database or a physical machine supporting a database in a distributed computer system.

The trace identifier may comprise a client connection identifier combined with an activity identifier. In one embodiment, the client connection identifier is a sixteen-byte, randomly generated globally unique identifier, and the activity identifier is a sixteen-byte, randomly generated globally unique identifier combined with a sequence number.

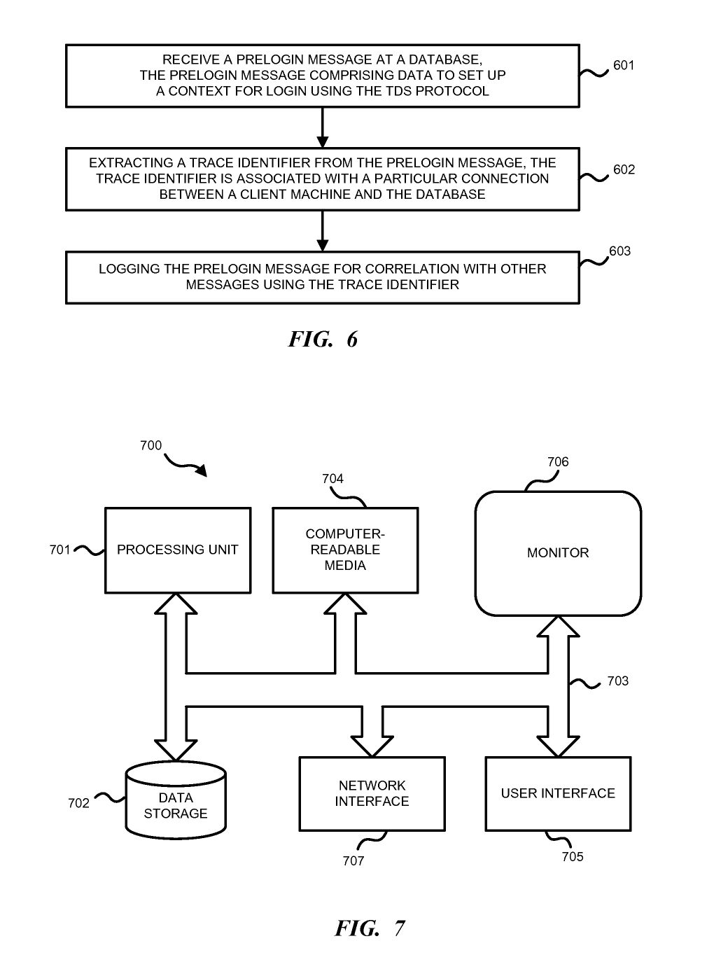

FIG. 6 is a flowchart illustrating a method or process for tracing connections at a database or server in a database system. In step 601, a prelogin message is received at a database. The prelogin message comprises data to set up a context for login using the TDS protocol. A trace identifier is extracted from the prelogin message in step 602. The trace identifier is associated with a particular connection between a client machine and the database. In step 603, the prelogin message is logged for correlation with other messages using the trace identifier.

It will be understood that steps 501-505 of the process illustrated in FIG. 5 and steps 601-603 of the process illustrated in FIG. 6 may be executed simultaneously and/or sequentially. It will be further understood that each step may be performed in any order and may be performed once or repetitiously.

FIG. 7 illustrates an example of a suitable computing and networking environment 700 on which the examples of FIGS. 1-6 may be implemented. Computing system 700 may be used as a client machine running a client application and/or as a database server running a SQL engine, for example. Multiple instances of computing system 700, such as one or more client machine instances, may be coupled to other instances of the computing system 700, such as one or more server database instances. The computing system environment 700 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 700. Components may include, but are not limited to, various hardware components, such as processing unit 701, data storage 702, such as a system memory, and system bus 703 that couples various system components including the data storage 702 to the processing unit 701. The system bus 703 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 700 typically includes a variety of computer-readable media 704. Computer-readable media 704 may be any available media that can be accessed by the computer 700 and includes both volatile and nonvolatile media, and removable and non-removable media, but excludes propagated signals. By way of example, and not limitation, computer-readable media 704 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 700. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 702 includes computer storage media in the form of volatile and/or nonvolatile memory such as read only memory (ROM) and random access memory (RAM). A basic input/output system (BIOS), containing the basic routines that help to transfer information between elements within computer 700, such as during start-up, is typically stored in ROM. RAM typically contains data and/or program modules that are immediately accessible to and/or presently being operated on by processing unit 701. By way of example, and not limitation, data storage 702 holds an operating system, application programs, and other program modules and program data.

Data storage 702 may also include other removable/non-removable, volatile/nonvolatile computer storage media. By way of example only, data storage 702 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 7, provide storage of computer-readable instructions, data structures, program modules and other data for the computer 700.

A user may enter commands and information through a user interface 705 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 701 through a user input interface 705 that is coupled to the system bus 703, but may be connected by other interface and bus structures, such as a parallel port, game port or a universal serial bus (USB). A monitor 706 or other type of display device is also connected to the system bus 703 via an interface, such as a video interface. The monitor 706 may also be integrated with a touch-screen panel or the like. Note that the monitor and/or touch screen panel can be physically coupled to a housing in which the computing device 700 is incorporated, such as in a tablet-type personal computer. In addition, computers such as the computing device 700 may also include other peripheral output devices such as speakers and printer, which may be connected through an output peripheral interface or the like.

The computer 700 may operate in a networked or cloud-computing environment using logical connections 707 to one or more remote devices, such as a remote computer. The remote computer may be a personal computer, a server, a router, a network PC, a peer device or other common network node, and typically includes many or all of the elements described above relative to the computer 700. The logical connections depicted in FIG. 7 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 700 may be connected to a public or private network through a network interface or adapter 707. In some embodiments, a modem or other means for establishing communications over the network. The modem, which may be internal or external, may be connected to the system bus 703 via the network interface 707 or other appropriate mechanism. A wireless networking component such as comprising an interface and antenna may be coupled through a suitable device such as an access point or peer computer to a network. In a networked environment, program modules depicted relative to the computer 700, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
generating a prelogin message on a client machine, the prelogin message comprising data to set up a context for login using a Tabular Data Stream (TDS) protocol;
inserting a trace identifier into the prelogin message, the trace identifier identifying a particular connection between the client machine and a database; and
transmitting the prelogin message to the database.

2. The computer-implemented method of claim 1, further comprising:
logging the prelogin message in one or more layers of a stack using a tracing operation.

3. The computer-implemented method of claim 1, further comprising:
logging the prelogin message in a client driver stack layer;
logging the prelogin message in a TDS protocol stack layer; and
logging the prelogin message in a database server stack layer.

4. The computer-implemented method of claim 3, further comprising:
correlating the logged prelogin message in the client driver stack layer, the TDS protocol stack layer, and the database server stack layer.

5. The computer-implemented method of claim 1, wherein the connection is between the client machine and an on-premises database.

6. The computer-implemented method of claim 1, wherein the connection is between the client machine and a virtual database in a distributed computer system.

7. The computer-implemented method of claim 1, wherein the connection is between the client machine and a physical machine supporting a database in a distributed computer system.

8. The computer-implemented method of claim 1, wherein the trace identifier comprises a client connection identifier combined with an activity identifier.

9. The computer-implemented method of claim 8, wherein the client connection identifier is a sixteen-byte, randomly generated globally unique identifier, and the activity identifier is a sixteen-byte, randomly generated globally unique identifier combined with a sequence number.

10. A computer system, comprising:
one or more processors;
system memory;
one or more computer-readable storage media having stored thereon computer-executable instructions that, when executed by the one or more processors, causes the processors to perform a method for tracing connections in a database system, the processor operating to:
generate a prelogin message on a client machine, the prelogin message comprising data to set up a context for login using a Tabular Data Stream (TDS) protocol;
insert a trace identifier into the prelogin message, the trace identifier identifying a particular connection between the client machine and a database; and
transmit the prelogin message to the database.

11. The computer system of claim 10, the processor further operating to:
log the prelogin message in one or more layers of a stack using a tracing operation.

12. The computer system of claim 10, the processor further operating to:
log the prelogin message in a client driver stack layer;
log the prelogin message in a TDS protocol stack layer; and
log the prelogin message in a database server stack layer.

13. The computer system of claim 10, the processor further operating to:
correlate the logged prelogin message in the client driver stack layer, the TDS protocol stack layer, and the database server stack layer.

14. The computer system of claim 10, wherein the connection is between the client machine and an on-premises database.

15. The computer system of claim 10, wherein the connection is between the client machine and a virtual database in a distributed computer system.

16. The computer system of claim 10, wherein the connection is between the client machine and a physical machine supporting a database in a distributed computer system.

17. The computer system of claim 10, wherein the trace identifier comprises a client connection identifier combined with an activity identifier.

18. The computer system of claim 10, wherein the client connection identifier is a sixteen-byte, randomly generated globally unique identifier, and the activity identifier is a sixteen-byte, randomly generated globally unique identifier combined with a sequence number.

19. A computer-implemented method, comprising:
receiving a prelogin message at a database, the prelogin message comprising data to set up a context for login using a Tabular Data Stream (TDS) protocol;
extracting a trace identifier from the prelogin message, the trace identifier identifying a particular connection between a client machine and the database; and
logging the prelogin message.

20. The computer-implemented method of claim 19, wherein the trace identifier comprises a client connection identifier combined with an activity identifier, and wherein the client connection identifier is a sixteen-byte, randomly generated globally unique identifier, and the activity identifier is a sixteen-byte, randomly generated globally unique identifier combined with a sequence number.
